(19) United States
(12) Patent Application Publication
(10) Pub. No.: US 2008/0120209 A1
(43) Pub. Date: May 22, 2008

(54) Combining accounting data with Bates Stamping feature

(75) Inventors: Marc J. Krolczyk, Spencerport, NY (US); Kara Allison Goldstein, Rochester, NY (US)

Correspondence Address: ORTIZ & LOPEZ, PLLC, P.O. Box 4484, Albuquerque, NM, 87196-4484, US

(73) Assignee: Xerox Corporation

(21) Appl. No.: 11/591,855

(22) Filed: Nov. 1, 2006

(51) Int. Cl. G07B 17/00

(52) U.S. Cl. 705/30

(57) ABSTRACT

An accounting record and a numbering record are automatically combined to create Bates numbers that are then automatically applied to the pages of input documents to produce Bates numbered documents. A document can be an electronic document or a printed document. A print job or a scanning job can be associated with an account and the account billed for the job. The account is associated with an accounting record. Choosing the account to bill also selects the accounting record to use for Bates numbering. The numbering record is persistent so that it doesn't change between documents. As such, Bates numbers can be automatically generated and applied to the pages of documents.

### TECHNICAL FIELD

Embodiments relate to the fields of printed documents, electronic documents, printing and scanning. Embodiments also relate to the field of facsimile transmission of electronic documents. Embodiments further relate to the field of Bates Stamping.

### BACKGROUND

Printers and scanners in modern office environments often have access to accounting data so that costs can be properly allocated among users, customers, departments, or otherwise. For example, a person can print a document by accessing the printer either manually or over a communications network, entering an account identifier and/or an optional password, and then commanding the printer to proceed with printing. The printer can then report the details of the print job so that the proper account can be billed.

Many printers can also scan documents to create an electronic document. The electronic document can then be electronically transmitted or printed. The printer's accounting features can be used to bill the appropriate account for scanning the document. Those skilled in the art of printers, scanners, and office workflow are familiar with printers and scanners incorporating accounting features. In particular, the Xerox Work Center product line incorporates the Xerox Standard Accounting Features that allow for tracking and invoicing print jobs based on accounting data.

Some documents require a different kind of tracking called Bates numbering. Bates numbering is often used in the legal realm for tracking evidence. Each page of each document that is evidence in a case can be given a Bates number. Originally, all documents were physical documents and a Bates numbering device was used for Bates numbering. The Bates numbering device is a special stamp that is inked and then pressed against a page. The Bates numbering device then automatically indexes to the next number. As such, a person can Bates number a pile of documents much quicker than would be possible if the stamp had to be manually indexed. For example, Bates numbering three documents of 15 pages each can result in the first document having Bates numbers 1 through 15, the second document having numbers 16 through 30, and the third document having numbers 31 through 45. The Bates numbering device is left indexed to the number 46. Should a fourth document be introduced, the Bates numbering for it begins at 46.

Refinements of Bates numbering have been introduced. Bates numbers can have a prefix and leading zeros. For example, the prefix “XRX” could be used to number the 46th page with the Bates number “XRX046”.

Software packages for the Bates numbering of electronic documents exist. The software takes an electronic document as input and applies Bates numbers to produce a Bates numbered electronic document.

Current technology, however, treats Bates numbering as a separate process that is not related to other office activities. Systems and methods to address the shortcomings of current technology are needed.

### BRIEF SUMMARY

Aspects of the embodiments address limitations and flaws in the prior art by automatically combining data held in an accounting record with data held in a numbering record to produce a sequence of Bates numbers that are applied to input documents.

It is therefore an aspect of the embodiments to provide an accounting record. The accounting record contains accounting fields such as an accounting identifier.

It is also an aspect of the embodiments to provide a numbering record. The numbering record specifies the index from which to continue subsequent Bates numbering. For example, the numbering record can contain the number 1025. In most applications, this indicates that 1024 pages have already received Bates numbers. The number of documents containing those 1024 Bates numbers is not specified. A number updating module changes the numbering record upon receiving a numbering event. A numbering module applies the Bates numbers to the pages. A numbering event occurs each time the Bates numbering module processes a page.

In most cases, the number updating module increments the numbering record by one. In some applications, a numbering rule can be used to alter the numbering sequence. For example, the numbering field can be incremented by two, or some other number. The numbering field can be incremented every second, third, or Nth page. When every page does not receive a Bates number the Bates numbering module can process a page without applying a Bates number to it and still generate a Bates numbering event.

It is another aspect of the embodiments to supply an input document. The input document can be a printed document loaded into a scanner, an electronic document passed to a printer, or some other form of document. In the case of a printed document, the scanner scans the printed document to produce an electronic document. A fax data stream is a type of electronic document that is typically passed from one facsimile machine to another.

It is a further aspect of the embodiments that a Bates numbering module uses the accounting record, the numbering field, and a Bates location specification to apply a Bates number to the pages of the input document such that a Bates numbered document is produced.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the background of the invention, brief summary of the invention, and detailed description of the invention, serve to explain the principles of the present invention.

FIG. 1 illustrates combining an accounting record and a numbering record to produce a Bates numbered printed document in accordance with aspects of the embodiments;

FIG. 2 illustrates using an accounting record and a numbering record to Bates number a scanned document for faxing in accordance with aspects of the embodiments;

FIG. 3 illustrates a graphical user interface controlling a Bates numbering module in accordance with aspects of the embodiments; and

FIG. 4 illustrates a high level flow diagram of using an accounting record and a numbering record when applying a Bates number to a document.

### DETAILED DESCRIPTION OF THE INVENTION

The particular values and configurations discussed in these non-limiting examples can be varied and are cited merely to illustrate embodiments and are not intended to limit the scope of the invention.

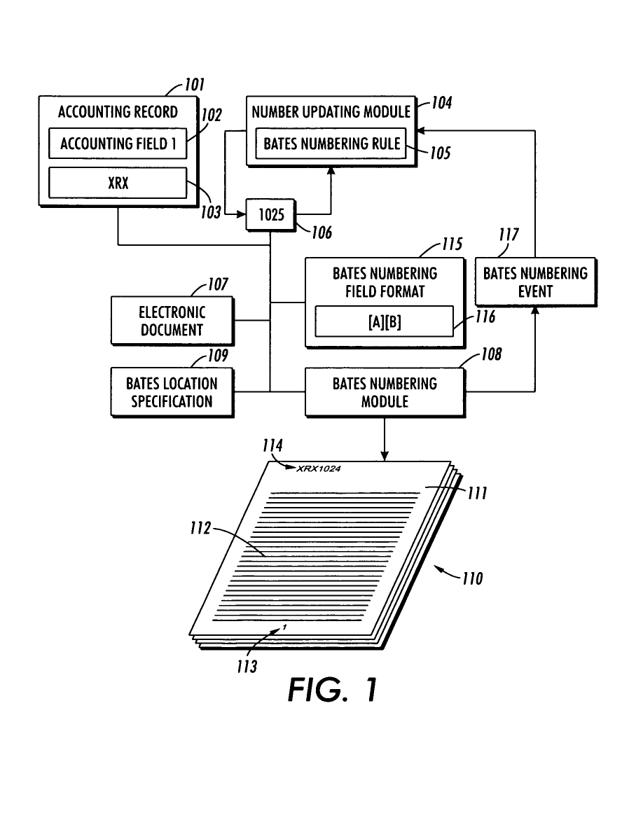

FIG. 1 illustrates combining an accounting record 101 and a numbering record 106 to produce a Bates numbered printed document in accordance with aspects of the embodiments. An accounting record 101 contains a first accounting field 102 and a second accounting field 103. The second accounting field 103 is illustrated as containing the account identifier “XRX”. Using accounting records with printers and scanners is known to those practiced in the art of enterprise class printing and scanning equipment.

A number updating module 104 contains a Bates numbering rule 105. The number updating module changes a numbering record 106 on the occurrence of a Bates numbering event 117. The numbering record 106 is illustrated outside of the accounting record 101, although some embodiments can store it within the accounting record 101. The numbering record 106 is also illustrated as containing the number 1025. The Bates numbering rule 105 can be “increment by 1” in which case the numbering record 106 is incremented to 1026. Many different rules are possible. Other examples include “increment by N” and “wait M numbering events then increment by N”. In the examples, N and M are integers. The numbering record is shown using a decimal (base 10) representation. Other representations such as octal (base 8) or hexadecimal (base 16) can be used. More generally, a base N representation can be used.

A number updating module 104 can implicitly contain a Bates numbering rule 105. For example, when using a simple counter as the number updating module 104, the Bates numbering rule 105 is “increment by 1” and is implicitly contained in the counter's design.

A Bates numbering field format 115 is illustrated as containing the “[A][B]” specifier 116. If, for example, the account identifier 103 is associated with the “A” field and the numbering record 106 is associated with the “B” field, the Bates number XRX1025 is generated. A format with three fields can be specified as “[A][B][C]” or simply as ABC. The number of ways for specifying the number of fields in a format and what those fields contain is limitless. Those familiar with computer programming know of many ways to format data and can easily produce equivalent format specifiers for forming Bates numbers from accounting records and numbering and fields.

A Bates numbering module 108 can receive an electronic document 107, an accounting record 101, a numbering record 106, a Bates numbering field format 115, and a Bates location specification 109 and produce a Bates numbered document 110. Here, the Bates numbered document 110 is a Bates numbered printed document 110 containing many pages such as the top page 111 that has text 112, a page number 113, and a Bates number 114. The Bates number “XRX1024” is placed in the upper left margin in accordance with the Bates location specification 109. Notice that the numbering record 106 has been incremented by one to change 1024 into 1025 because a Bates numbering event 117 was generated when the Bates numbering module 108 processed the top page 111.

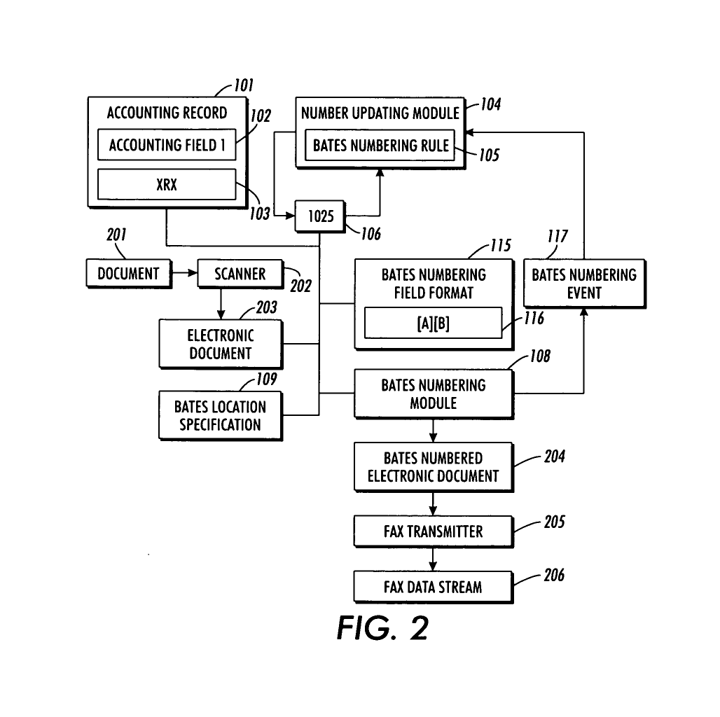

FIG. 2 illustrates using an accounting record 101 and a numbering record 106 to Bates number a scanned document for faxing in accordance with aspects of the embodiments. The system of FIG. 1 and that of FIG. 2 have many common elements. As such, the differences will be discussed. The system of FIG. 2 accepts a document 201 that is scanned by a scanner 202 to produce an electronic document 203. The electronic document 203 is passed to the Bates numbering module 108 where the Bates numbers are applied to produce a Bates numbered electronic document 204.

The Bates numbered electronic document 204 can be printed to produce a printed document similar to the Bates numbered printed document 110 of FIG. 1. The Bates numbered electronic document 204 and the Bates numbered printed document 110 are different types of Bates numbered documents. In FIG. 2, a fax transmitter 205 receives the Bates numbered electronic document 204 and encodes it into a fax data stream 206. Presumably, a fax receiver will receive the fax data stream 206 and produce a copy of the Bates numbered document.

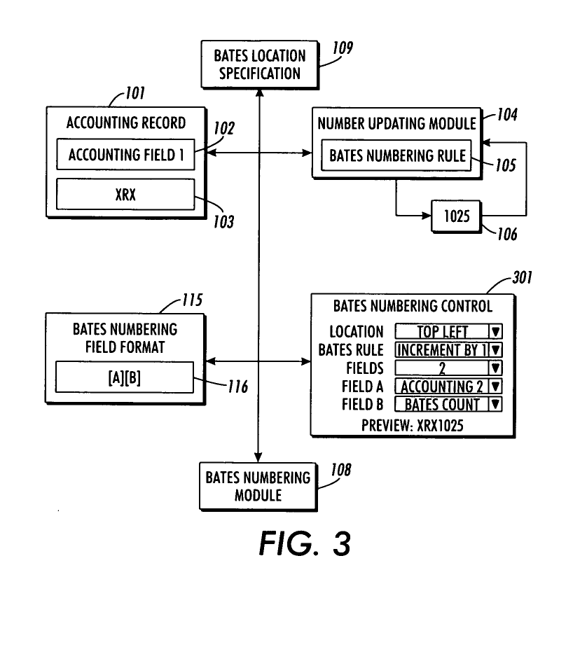

FIG. 3 illustrates a graphical user interface (GUI) 301 controlling a Bates numbering module 108 in accordance with aspects of the embodiments. In one particular embodiment, the GUI 301 can contain five input fields. Such a configuration, however, is not limited to 5 fields. Additional text attributes could be included such as text size, color, font, and so forth in accordance with other embodiments. Thus, the “Location” may have the “Top Left” selected. The Bates Location Specification 109 can thereby be set to specify a top left position for the Bates number as illustrated on the top page 111 of FIG. 1. “Bates Rule” has “increment by 1” selected which can be set as the Bates numbering rule 105. “Fields” is set to “2” indicating the Bates number field format 115 should be set to include 2 fields as is shown in the stored format 116.

“Field A” is set to “Accounting 2” indicating the second accounting field 103. “Field B” is set to “Bates Count” indicating the numbering record 106 containing 1025. As such, the GUI shows a preview of the Bates number as “XRX1025”. Embodiments can use a default Bates numbering field format and the GUI can lack functionality for changing the default. For example, the field format that produced the “XRX1025” Bates number can be an unchangeable default format.

The GUI 301 is illustrated as using selection boxes to obtain values for the input fields. Other GUI elements can equivalently by used such as menus, radio buttons, dials, or any other GUI input field element.

The various values, such as the Bates numbering rule 105, numbering record 106 Bates numbering field format 115, and Bates location specification 109 can be stored in a non volatile memory, such a disk drive or flash chip, so that they can be used for Bates numbering future documents under the account referenced in the accounting record.

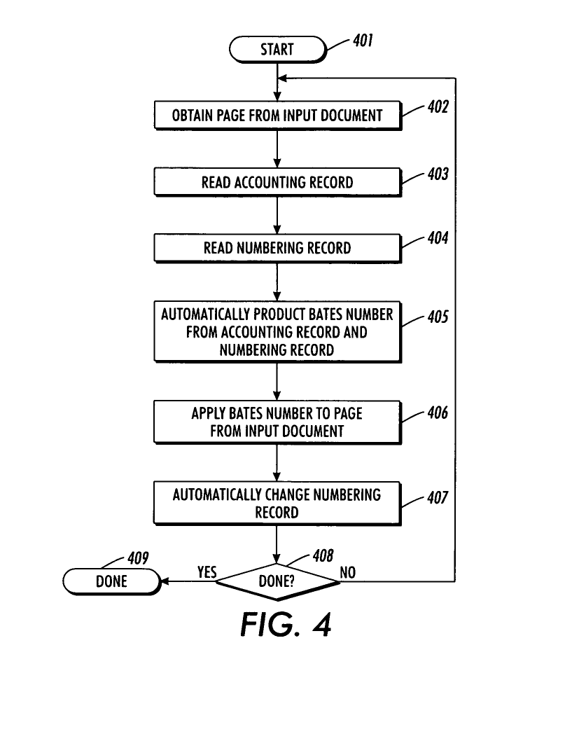

FIG. 4 illustrates a high level flow diagram of using an accounting record 101 and a numbering record 106 when applying a Bates number to a document. After the start 401 a page is obtained from an input document 402. The input document can be printed or electronic. The accounting record is read 403 and the numbering record is read 404. A Bates number is automatically generated 405 and applied to the page 406 creating a Bates numbering event. The Bates numbering event can cause the numbering record to be changed 407. If there are no more pages 408, then the process is done 409. Otherwise, the process loops back to obtaining a page 402. Notice that the pages of numerous input documents can be processed because the process flow continues until the last page of the last document is processed.

Embodiments can be implemented in the context of modules. In the computer programming arts, a module can be typically implemented as a collection of routines and data structures that performs particular tasks or implements a particular abstract data type. Modules generally can be composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules, hardware modules, or implementations thereof. Such modules can be utilized separately or together to form a program product that can be implemented through signal-bearing media, including transmission media and recordable media.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system comprising:
an electronic document;
an accounting record comprising at least one accounting field;
a numbering record and a number updating module wherein the number updating module automatically changes the numbering record on the occurrence of a Bates numbering event;
a Bates numbering module that uses the accounting record, the numbering record, the electronic document, and a Bates location specification to produces a Bates numbered document comprising at least one page wherein the at least one page comprises at least one Bates number.

2. The system of claim 1 wherein the Bates numbered document is a printed document.

3. The system of claim 2 further comprising a Bates numbering field format wherein the at least one Bates number is formatted in accordance with the Bates numbering field format.

4. The system of claim 3 further comprising a Bates numbering rule wherein the number updating module uses the Bates numbering rule when changing the numbering record.

5. The system of claim 4 further comprising a graphical user interface wherein the graphical user interface is used to control the Bates numbering module.

6. The system of claim 5 wherein the electronic document data is a fax data stream.

7. A system comprising:
a scanner that scans a document to produce an electronic document comprising at least one page;
an accounting record comprising at least one accounting field;
a numbering record and a number updating module wherein the number updating module automatically changes the numbering record on the occurrence of a Bates numbering event;
a Bates numbering module that uses the accounting record, the numbering record, and a Bates location specification to apply a Bates number to the at least one page to thereby produce a Bates numbered electronic document.

8. The system of claim 7 further comprising a Bates numbering field format wherein the at least one Bates number is formatted in accordance with the Bates numbering field format.

9. The system of claim 8 further comprising a Bates numbering rule wherein the number updating module uses the Bates numbering rule when changing the numbering record.

10. The system of claim 9 further comprising a graphical user interface wherein the graphical user interface is used to control the Bates numbering module.

11. The system of claim 9 further comprising a fax transmitter that transmits the Bates numbered electronic document as a fax data stream.

12. A method comprising:
obtaining one of at least one input page wherein an input document comprises the at least one input page;
automatically producing a Bates number from an accounting record and a numbering record wherein the accounting record comprises at least one accounting field;
applying the Bates number to the one of at least one input page to produce one of at least one Bates numbered page wherein a Bates numbered document comprises the at least one Bates numbered page; and
automatically updating the numbering record.

13. The method of claim 12 wherein the input document is an electronic document.

14. The method of claim 12 wherein the output document is a printed document.

15. The method of claim 12 wherein the output document is an electronic document.

16. The method of claim 12 further comprising formatting the Bates number is formatted in accordance with a Bates numbering field format.

17. The method of claim 13 further comprising changing the numbering record based on a Bates numbering rule.

18. The method of claim 12 further comprising:
using a graphical user interface to control the automatic production of the Bates number;
formatting the Bates number is formatted in accordance with a Bates numbering field format;
changing the numbering record based on a Bates numbering rule; and
wherein the input document is an electronic document, and wherein the output document is an electronic document.
